(19) United States
(12) Patent Application Publication
(10) Pub. No.: US 2024/0318029 A1
(43) Pub. Date: Sep. 26, 2024

(54) Optically Clear, Stretchable, Crosslinked Thin Film Polymeric Barrier Layers Protecting Optical Devices

(71) Applicant: University of Rochester, Rochester, NY (US)

(72) Inventors: Wyatt Tenhaeff, Rochester, NY (US); Yineng Zhao, Rochester, NY (US); Sheng Ye, Redmond, WA (US); Andrew Ouderkirk, Redmond, WA (US)

(21) Appl. No.: 18/270,035

(22) PCT Filed: Dec. 22, 2021
(86) PCT No.: PCT/US2021/064793

§ 371 Date: Jun. 28, 2023

Related U.S. Application Data
(60) Provisional application No. 63/131,171, filed on Dec. 28, 2020.

(51) Int. Cl. C09D 133/16; G02B 1/18

(52) U.S. Cl. CPC C09D 133/16; G02B 1/18

(57) ABSTRACT

A barrier coating for optical devices or elements that comprises poly(1H, 1H,6H,6H-perfluorohexyl diacrylate) (pFHDA) and has desirable characteristics such as oil permeation protection, increased transparency, and thermal stability.

### FIELD

This patent specification relates to optical devices and more specifically to barrier layers protecting optical devices such as lenses and other optical elements against environmental contaminants such as oil.

### BACKGROUND AND SUMMARY

Passive and active optical devices can be undesirably affected by environmental effects such as oil that change optical properties.

This patent specification describes thin film polymers that are uniquely suited to reduce undesirable effects of such contaminants on optical properties. The polymers form a thin, optically transparent film on optical devices that functions as an oil permeation barrier.

The barrier layer is a thin, crosslinked polymer thin film that functions as an oil permeation barrier. A preferred polymer composition is poly(1H, 1H,6H,6H-perfluorohexyl diacrylate) (pPFHDA), which is synthesized as a thin film using initiated chemical vapor deposition (iCVD) or other suitable processes for forming a thin film. Typical thicknesses range form 10-1000 nm and are applied to thermoplastic polyurethane (TPU) substrates as examples of optical devices or elements. If oil is dispersed on top of pPFHDA-coated TPU, there is no observable oil absorption into the TPU in the tests that were carried out. On untreated TPU, oil rapidly permeates into TPU, resulting in oil beading, which scatters light and reduces the tension of the TPU. In addition to being very thin, the polymer is optically transparent. The polymer is also flexible, able to accommodate deformation of underlying substrate.

According to some embodiments, an optical device comprises a substrate with a transparent barrier coating comprising poly(1H, 1H,6H,6H-perfluorohexyl diacrylate) (pPFHDA) having the chemical structure

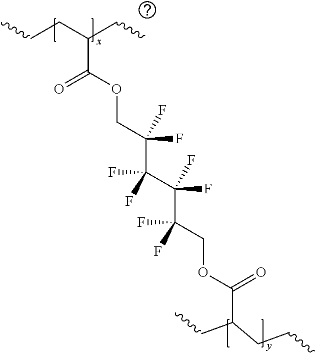

The optical device can further include one or more of the following features: (a) the barrier coating thickness is in the range of 10-1000 nm; (b) the barrier coating exhibits consistent line tension over a period in excess of a month at 70 degrees Centigrade; (c) the barrier coating exhibits light transmittance greater than that of the substrate for light at least in the wavelength range of 400-1000 nm; (e) the barrier coating exhibits increased static contact angles for both oil and water; (f) the barrier coating exhibits a thickness change of less than 2% after 24 hours of immersion in oil; and (g) the barrier coating exhibits thermal stability characterized by weight retention in excess of 95 percent at temperatures up to at least 300 degrees Centigrade.

According to some embodiment, a transparent barrier coating for optical devices or elements comprises poly(1H, 1H,6H,6H-perfluorohexyl diacrylate) (pPFHDA), and can further include one or more of the following features: (a) the barrier coating has the chemical structure

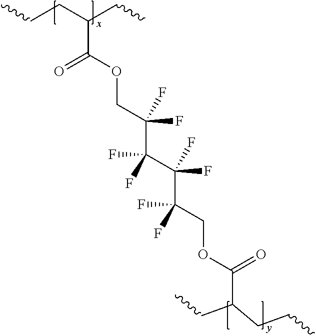

(b) the barrier coating has a thickness in the range of 10-1000 nm; (c) the barrier coating is characterized by having a consistent line tension over a period in excess of a month at 70 degrees Centigrade; (d) the barrier coating exhibits increased static contact angles for both oil and water; (e) the barrier coating is characterized by a thickness change of less than 2% after 24 hours of immersion in oil; (f) the barrier coating has thermal stability characterized by weight retention in excess of 95 percent at temperatures up to at least 300 degrees Centigrade.

According to some embodiments, a method of protecting an optical device comprises coating a surface of the device with a barrier layer comprising poly(1H, 1H,6H,6H-perfluorohexyl diacrylate) (pPFHDA) having the chemical structure

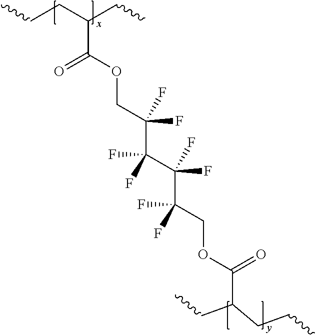

According to some embodiments, the method can further include one or more of the following: (a) the coating step can comprise coating to a thickness of 100-1000 nm; (b) the coating step can comprise coating a substrate with a barrier layer that increases light transmittance through the barrier layer and substrate compared to the substrate alone for light at least in the wavelength range of 400-1000 nm; (c) said coating comprises a highly crosslinked polymer thin films fabricated from multifunctional monomers; (d) the coating comprises ethylene glycol diacrylate; and (e) the barrier coating comprises highly crosslinked copolymers composed of monofunctional perfluoroalkyl acrylates and difunctional monomers.

### BRIEF DESCRIPTION OF THE DRAWINGS

FIG. 1 illustrates light transmittance comparison between a substrate coated with a preferred barrier layer (pPFHDA) and a substrate that is uncoated, after immersion in oil.

FIG. 2 shows a cross-section of a substrate coated with a preferred barrier layer and shows a chemical structure of the layer.

FIG. 3 shows results of oil permeation tests.

FIG. 4 shows results of Fourier transform infrared spectroscopy (FTIR) characterization.

FIG. 5 shows a chemical structure of a monomer precursor (PFHDA). (1H, 1H,6H,6H-perfluorohexyl diacrylate).

FIG. 6 shows results of light transmittance tests.

FIG. 7 illustrates side views of water and oil beads on a substrate coated with a preferred barrier layer and on a substrate that is uncoated.

FIG. 8 shows results of oil and water swelling tests with a preferred barrier layer.

FIG. 9 shows results of thermal behavior tests of a preferred barrier layer. T

### DETAILED DESCRIPTION

A detailed description of examples of preferred embodiments is provided below. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all of these details. Moreover, for the purpose of clarity, certain technical material that is known in the related art has not been described in detail to avoid unnecessarily obscuring the new subject matter described herein. Individual features of one or several of the specific embodiments described herein can be used in combination with features of other described embodiments or with other features.

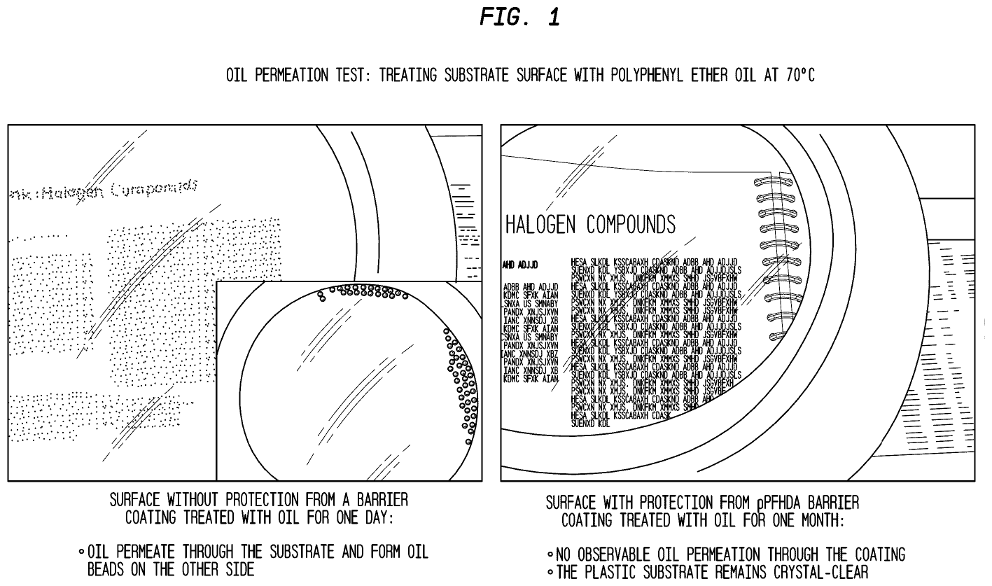

FIG. 1 is a top view of a plastic sheet substrate composed of thermoplastic polyurethane (TPU) that has been treated with oil at one surface. The left panel of FIG. 1 shows the substrate without a barrier layer protection after treatment with oil for one day—the oil has permeated the sheet and has formed oil beads at the opposite surface, obscuring an underlying text. The right panel shows a substrate that is otherwise the same but has a barrier coating as described below. The side with the barrier coating has been treated with the same oil but in this case for a month rather than a day. The substrate with the barrier coating has no observable oil permeation through the coating and the plastic substrate has remained clear. The text underneath the substrate is legible.

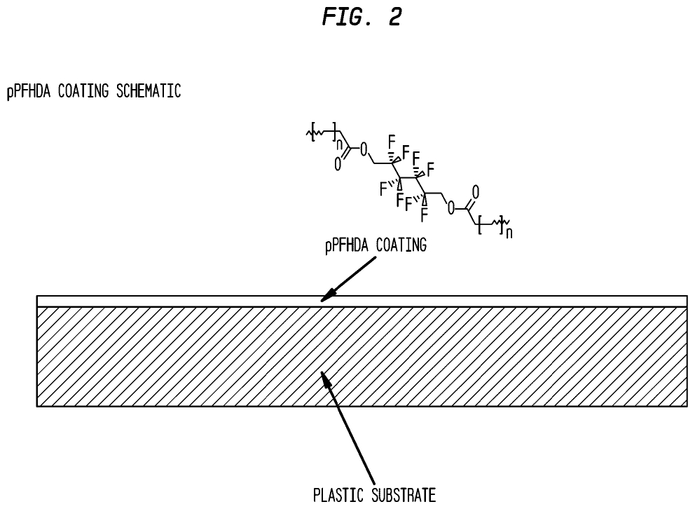

FIG. 2 shows a cross-section of a plastic sheet substrate with a barrier layer on a top surface. The barrier layer is a thin, crosslinked polymer thin film that functions as an oil permeation barrier. The polymer composition is poly(1H, 1H,6H,6H-perfluorohexyl diacrylate) (pPFHDA), which is synthesized as a thin film using initiated chemical vapor deposition (iCVD). Typical thicknesses of this film range form 10-1000 nm. The barrier layer is applied to a substrate such as a thermoplastic polyurethane (TPU) substrate. FIG. 2 also shows the chemical structure of the pPFHDA coating.

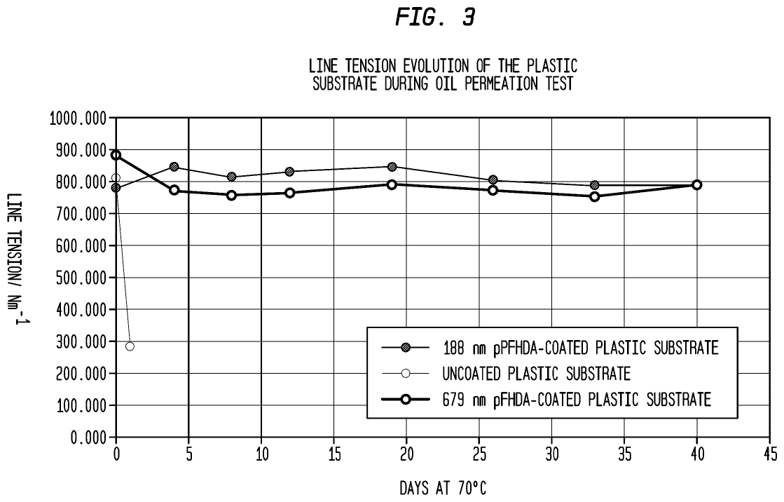

FIG. 3 shows results of an oil permeation test to assess performance of a substrate with a 188 nm thick barrier layer protection using the composition of FIG. 2 (pPFHDA) relative of the same substrate with a 679 nm thick layer of the same barrier layer protection and relative to a substrate without a protective barrier. The vertical axis is Line Tension (units of N m⁻¹), and the horizontal axis is days in which the material was immersed in oil and kept at 70 degrees Centigrade. Line tension was collected by a customized bulge tester. Line tension drop indicates oil penetration into the substrate, through the coating for the coated substrates where the substrate is coated. The curve with solid dots is for a plastic substrate coated with a 188 nm thick layer of pPFHDA polymer barrier, the curve for uncoated substrate is the nearly vertical line with small circles, and the curve with large dots is for the plastic substrate coated with a 679 nm thick layer of pPFHDA polymer barrier.

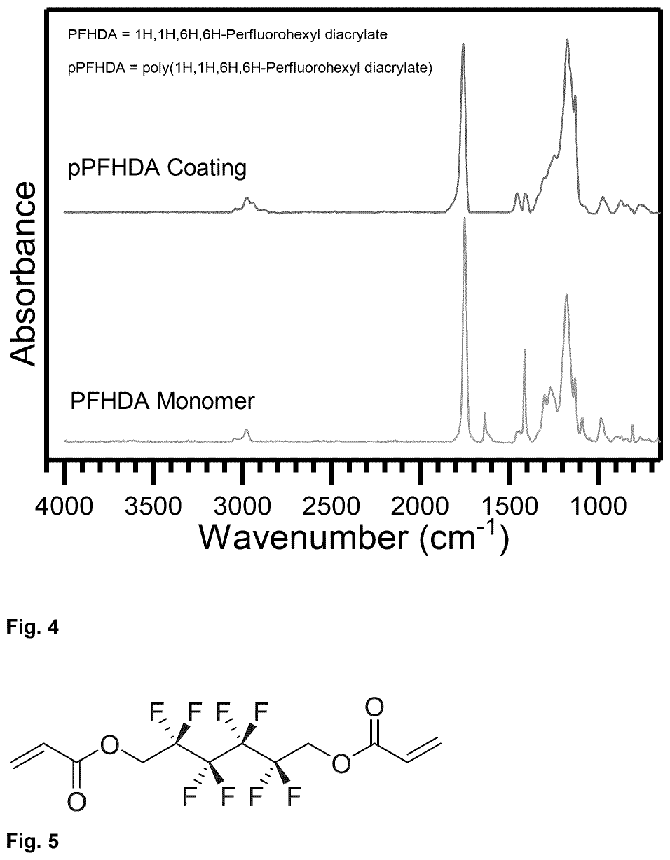

FIG. 4 shows absorbance vs. wavenumber (cm⁻¹) of light for a preferred polymer coating (pPFHDA) and for a monomer coating (1H, 1H,6H,6H-perfluorohexyl diacrylate; PFHDA) the chemical structure of which is shown in FIG. 5. PFHDA monomer has absorbance band at approximately 1630 cm⁻¹ but it is absent in pPFHDA. This band is associated with the vibrational mode of C═C stretch in PFHDA monomer. Its absence in pPFHDA indicates that the monomer has been converted into polymer network.

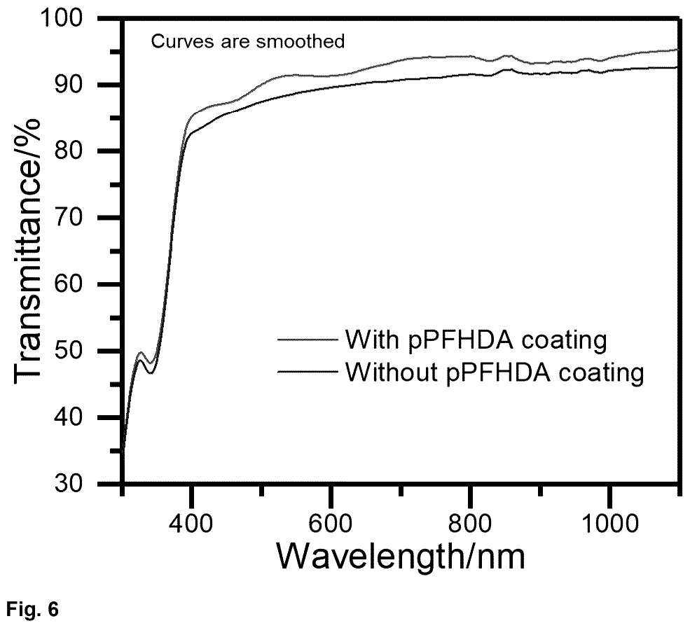

FIG. 6 shows results of transmittance tests indicating that the preferred barrier coating does not compromise light transmittance and can even increase transmittance. The increase can be attributed to the lower refractive index of pPFHDA coating (1.42) than most polymers. It can induce anti-reflection effect which then increases transmittance of the coated substrate. In FIG. 6, the vertical axis is % transmittance and the horizontal axis is wavelength of the transmitted light in nm. The upper curve is for a substrate coated with the preferred barrier and the lower curve is for the uncoated substrate. The barrier coating is on TPU, and the absorption below 400 nm to 300 nm is mainly caused by TPU not the coating.

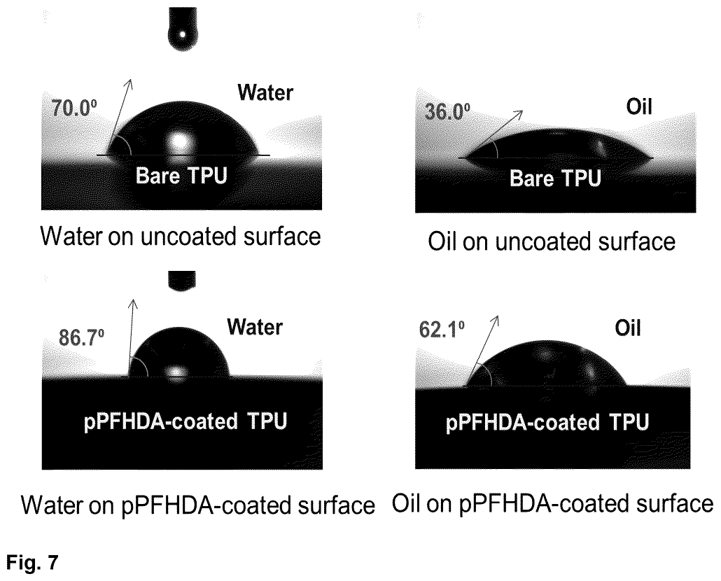

FIG. 7 illustrates Increased static contact angles for both oil and water after coating is applied and indicates that the coating reduces affinity towards both water and oil of the plastic substrate, which is thermoplastic polyurethane. The left side of FIG. 7 shows at upper left a water bead on an uncoated substrate at an angle of 70.0 degrees to the substrate and shows at lower left a water bead at 86.7 degrees on the same TPU substrate but in this case coated with the preferred barrier layer. FIG. 7 shows at upper right an oil bead on the same uncoated substrate at an angle of 36.0 degrees to the substrate and shows at lower right an oil bead at 62.1 degrees on the same substrate coated with the preferred barrier layer. As evident from FIG. 7, the preferred coating reduces affinity toward both water and oil and increases contact angles.

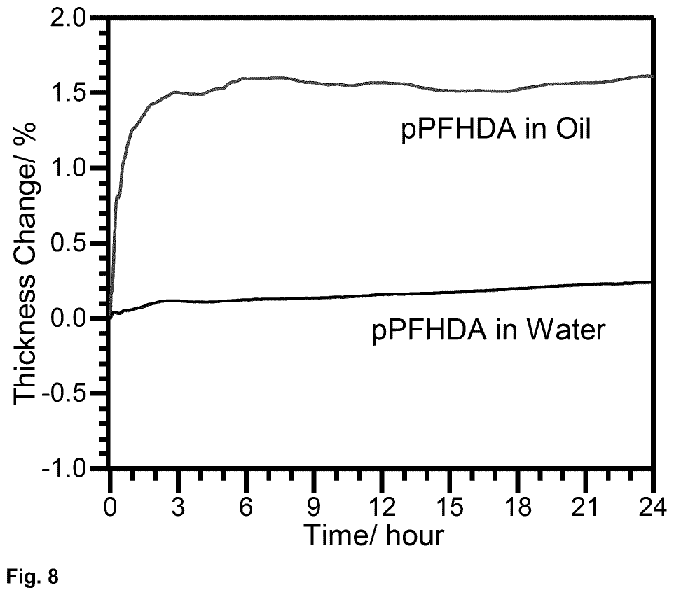

FIG. 8 illustrates that the preferred pPFHDA barrier coating affords strong resistance to both water and oil. The vertical axis in % change of the barrier layer and the horizontal axis if time of immersion in water or oil in hours. The thickness increase is negligible (<0.3%) when the material is immersed in water. Even for oil, the thickness only increases by 1.5% and stabilizes after 3 hours.

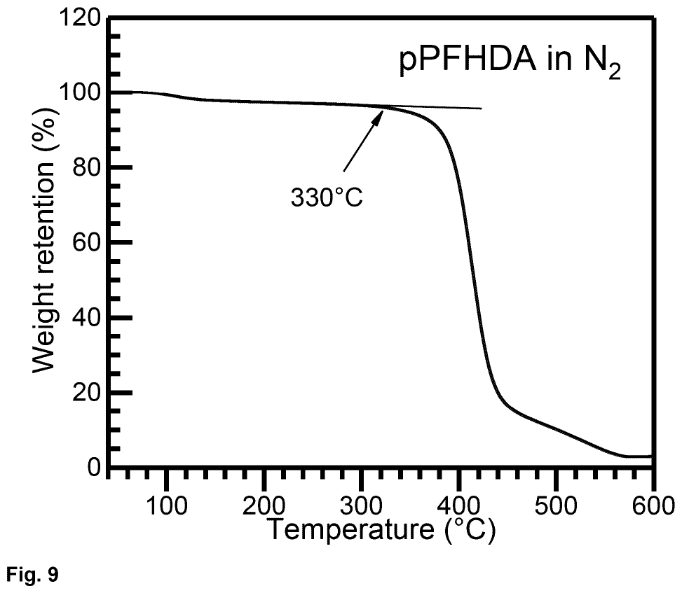

FIG. 9 shows that the preferred coating has good thermal stability. The vertical axis is % weight reduction of the coating and the horizontal axis is temperature in degrees Centigrade. There is very little weight reduction up to roughly 300 degrees Centigrade, which is well above temperatures that the coating is likely to encounter in typical applications as a barrier over optical devices or elements.

The preferred barrier coating described above is pPFHDA with a chemical structure as shown in FIG. 2. However, alternative materials are contemplated, including but not limited to thin, highly crosslinked polymer thin films fabricated from multifunctional monomers. For example, ethylene glycol diacrylate can be used. Another class is highly crosslinked copolymers composed of monofunctional perfluoroalkyl acrylates and difunctional monomers. The fluorinated monomers are important for hydrophobicity and oleophobicity. The difunctional monomer results in crosslinking that limits permeability.

While preferred embodiments have been shown and described herein, it will be apparent to those skilled in the art that such embodiments are provided by way of example only. Numerous variations, changes, and substitutions will now occur to those skilled in the art without departing from the invention. Various alternatives to the embodiments of the invention described herein may be employed in practicing the invention. It is intended that the following claims define the scope of the invention and that methods and structures within the scope of these claims and their equivalents be covered thereby.

1. An optical device comprising a substrate with a transparent barrier coating comprising poly(1H, 1H,6H,6H-perfluorohexyl diacrylate) (pPFHDA) having the chemical structure

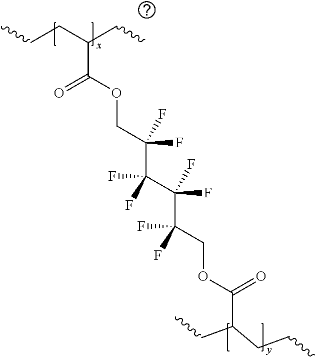

2. The optical device of claim 1, in which the barrier coating thickness is in the range of 10-1000 nm.

3. The optical device of claim 2, in which the barrier coating exhibits consistent line tension over a period in excess of a month at 70 degrees Centigrade.

4. The optical device of claim 2, in which the barrier coating exhibits light transmittance greater than that of the substrate for light at least in the wavelength range of 400-1000 nm.

5. The optical device of claim 2, in which the barrier coating exhibits increased static contact angles for both oil and water relative to the substrate alone.

6. The optical device of claim 2, in which the barrier coating exhibits a thickness change of less than 2% after 24 hours of immersion in oil.

7. The optical device of claim 2, in which the barrier coating exhibits thermal stability characterized by weight retention in excess of 95 percent at temperatures up to at least 300 degrees Centigrade.

8. A transparent barrier coating for optical devices or elements, said coating comprising poly(1H, 1H,6H,6H-perfluorohexyl diacrylate) (pPFHDA).

9. The barrier coating of claim 8 having the chemical structure

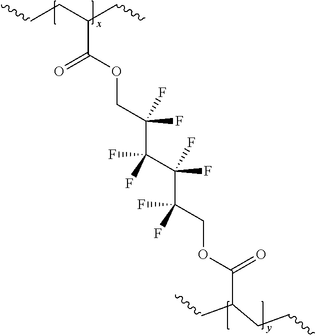

10. The barrier coating of claim 8, having a thickness in the range of 10-1000 nm.

11. The barrier coating of claim 8, characterized by having a consistent line tension over a period in excess of a month at 70 degrees Centigrade.

12. The barrier coating of claim 8, wherein the coating exhibits increased static contact angles for both oil and water relative to the devices or elements without the barrier coating.

13. The barrier coating of claim 8, characterized by a thickness change of less than 2% after 24 hours of immersion in oil.

14. The barrier coating of claim 8, having thermal stability characterized by weight retention in excess of 95 percent at temperatures up to at least 300 degrees Centigrade.

15. A method of protecting an optical device comprising coating a surface of the device with a barrier layer comprising poly(1H, 1H,6H,6H-perfluorohexyl diacrylate) (pPFHDA) having the chemical structure

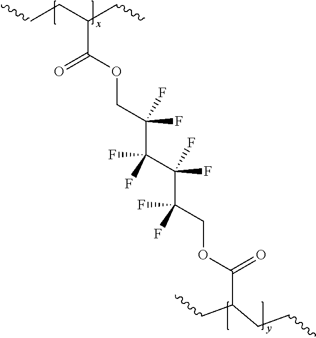

16. The method of claim 15, in which the coating step comprises coating to a thickness of 100-1000 nm.

17. The method of claim 15, in which the coating step comprises coating a substrate with a barrier layer that increases light transmittance through the barrier layer and substrate compared to the substrate alone for light at least in the wavelength range of 400-1000 nm.

18. A barrier coating over a substrate, said coating comprising a highly crosslinked polymer thin films fabricated from multifunctional monomers.

19. The barrier coating over a substrate of claim 18, in which the coating comprises ethylene glycol diacrylate.

20. The barrier coating over a substrate of claim 18, in which the barrier coating comprises highly crosslinked copolymers composed of monofunctional perfluoroalkyl acrylates and difunctional monomers.
